(19) United States
(12) Patent Application Publication
(10) Pub. No.: US 2024/0238151 A1
(43) Pub. Date: Jul. 18, 2024

(54) STIMULATION DEVICE FOR PROVIDING SEXUAL STIMULATION

(71) Applicant: HYTTO PTE. LTD.

(72) Inventor: Dan LIU, Guangzhou (CN)

(21) Appl. No.: 18/500,694

(22) Filed: Nov. 2, 2023

Related U.S. Application Data
(60) Provisional application No. 63/479,564, filed on Jan. 12, 2023.

(51) Int. Cl. A61H 9/00; A61H 19/00

(52) U.S. Cl. CPC A61H 9/0057; A61H 19/00; A61H 2201/1246; A61H 2201/1664; A61H 2201/1685

(57) ABSTRACT

Embodiments of the present disclosure disclose a stimulation device. The stimulation device includes a drive unit, a linear reciprocating mechanism, and a housing. The linear reciprocating mechanism includes a distal end as a motional member. The motional member is configured to couple a detachable stimulator of the stimulation device. A proximal end of the linear reciprocating mechanism is operably connected to the drive. The linear reciprocating mechanism is configured to convert a power output of the drive unit into a reciprocating motion of the motional member to move the detachable stimulator reciprocally. The housing is configured to provide a covering to at least one of the drive unit and the linear reciprocating mechanism. The housing includes a mouth portion configured to allow a portion of the detachable stimulator to pass through. Further, the detachable stimulator is a detachable suction head.

### TECHNICAL FIELD

The present disclosure relates to sexual stimulation devices and, more particularly relates to a sexual stimulator designed to engage and provide sexual stimulation to the human body, with a particular emphasis on the clitoris.

### BACKGROUND

The clitoris is recognized as the most sensitive erogenous zone in the human female body, housing numerous nerve endings. It serves as a primary source of sexual pleasure for women, eliciting sexual arousal when stimulated. Sexual stimulation can be achieved through various means, such as mental stimulation, foreplay with a partner, or self-stimulation, ultimately leading to orgasm. Typically, manual or oral methods (cunnilingus) are considered the most effective forms of direct clitoral stimulation. In instances involving sexual penetration, these activities may also be referred to as supplementary or assisted clitoral stimulation. Notably, due to the glans' or clitoris' heightened sensitivity, direct stimulation of this region is not always pleasurable. Instead, women often prefer indirect touch, focusing on the hood or surrounding areas near the glans. Many find pleasure in using the hood to stimulate the clitoris or glans or in rolling the clitoris or glans between the labia's lips.

Consequently, a variety of tools have been developed to stimulate the erogenous zones of the human body. For instance, vibrators are commonly employed to provide targeted stimulation through direct contact with the skin. However, the use of vibrators for stimulation can sometimes result in skin irritations or inflammations. Additionally, individuals may have personal hygiene concerns or reservations that deter them from using such tools in direct contact with their genital area.

### SUMMARY

Various embodiments of the present disclosure provide a stimulation device for providing sexual stimulation and enhancing sexual arousal in the user's body.

According to an aspect of the present disclosure, a stimulation device is provided. The stimulation device includes a drive unit, a linear reciprocating mechanism, and a housing. The linear reciprocating mechanism includes a proximal end and a distal end. The proximal end is operably connected to the drive unit and the distal end is a motional member which is configured to couple a detachable stimulator of the stimulation device. The linear reciprocating motion is configured to convert a power output of the drive unit into a reciprocating motion of the motional member, thereby resulting the detachable stimulator to reciprocate. A housing of the stimulation device is configured to provide a covering to at least the drive unit and the linear reciprocating mechanism. The housing includes a mouth portion. The mouth portion is configured to allow a portion of the detachable stimulator to pass through. Further, the detachable stimulator is a detachable suction head.

According to another aspect of the present disclosure, a stimulation device is provided. The stimulation device includes a housing having a mouth portion, a drive unit covered by the housing, a chamber, and a linear reciprocating mechanism. The chamber is located at the mouth portion. The chamber includes an elastic membrane and an opening adapted to be engaged with a portion of a body of a user. The opening of the chamber is a single opening provided at an exterior of the stimulation device. The linear reciprocating mechanism has a distal end. The linear reciprocating mechanism is configured to convert a power output of the drive unit into a reciprocating motion of the distal end. The distal end creates periodic impact of the elastic membrane. As a result, the elastic membrane alternatively causes compression and relaxation that generates a change in air pressure within the chamber. This provides sexual stimulation to the portion of the body of the user through the opening of the chamber.

According to yet another aspect of the present disclosure, a detachable suction head is provided. The detachable suction head includes an outer wall, a flexible inner wall engaged to the outer wall, and a chamber. The outer wall is configured to be concentrically mounted to a mouth portion of a stimulation device. The chamber is defined by the outer wall and the flexible inner wall.

The chamber has an opening adapted to be engaged with a portion of a body of a user. The opening of the chamber is a single opening provided at an exterior of the stimulation device when the outer wall engages with the mouth portion.

### BRIEF DESCRIPTION OF THE FIGURES

The following detailed description of illustrative embodiments is better understood when read in conjunction with the appended drawings. To illustrate the present disclosure, exemplary constructions of the disclosure are shown in the drawings. However, the present disclosure is not limited to a specific device, or a tool and instrumentalities disclosed herein. Moreover, those in the art will understand that the drawings are not to scale.

FIG. 1 illustrates a perspective view of a stimulation device, in accordance with an embodiment of the present disclosure;

FIG. 2 illustrates an exploded view of the stimulation device of FIG. 1, in accordance with an embodiment of the present disclosure;

FIG. 3A illustrates a sectional view of the stimulation device in a backward position of a motional sleeve of FIG. 1, in accordance with an embodiment of the present disclosure;

FIG. 3B illustrates a sectional view of the stimulation device in a forward position of the motional sleeve of FIG. 1, in accordance with an embodiment of the present disclosure;

FIG. 4A illustrates a sectional view of the stimulation device in a backward position of a motional sleeve, in accordance with another embodiment of the present disclosure;

FIG. 4B illustrates a sectional view of the stimulation device in a forward position of the motional sleeve, in accordance with another embodiment of the present disclosure;

FIG. 5A illustrates a sectional view of the stimulation device in a backward position of a motional sleeve, in accordance with another embodiment of the present disclosure;

FIG. 5B illustrates a sectional view of the stimulation device in a forward position of the motional sleeve, in accordance with another embodiment of the present disclosure; and

FIG. 6 is a block diagram of a controller of the stimulation device, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments.

Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

In the context of the specification, the term “processor” refers to one or more of microprocessors, a microcontroller, a general-purpose processor, a Field Programmable Gate Array (FPGA) or an Application Specific Integrated Circuit (ASIC), and the like.

In the context of the specification, the phrase “memory unit” refers to one or more of a volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc., or a non-volatile storage memory such as EPROM, EEPROM or flash memory or the like.

In the context of the specification, the phrase “communication interface” refers to a device or a module enabling direct connectivity via wires and connectors such as USB, HDMI, VGA, or wireless connectivity such as Bluetooth or Wi-Fi, or Local Area Network (LAN) or Wide Area Network (WAN) implemented through TCP/IP, IEEE 802.x, GSM, CDMA, LTE, or other equivalent protocols.

### Overview

Various embodiments of the present disclosure provide a stimulation device for sexually stimulating the body of a user. The stimulation device includes a drive unit that is operably coupled with a linear reciprocating mechanism. The drive unit, which can be a motor, is operated by a user device or one or more switch elements of the stimulation device. The linear reciprocating mechanism can be a crank-link mechanism, a ball screw mechanism, a belt-drive linear actuator, a linear motor, a slider-crank mechanism, a hydraulic linear actuator, or a pneumatic linear actuator.

Additionally, the stimulation device includes a motional member, a stationary sleeve, a housing, and a detachable suction head. The detachable suction head is attached to a main body of the housing through a magnetic fastener or a snap-fit fastener. The stationary sleeve, which is configured to allow the reciprocating motion of the motional sleeve, is mounted to the housing through a holding gasket. The detachable suction head consists of an outer wall and a flexible inner wall that, together, define a chamber with an opening. The outer wall is flexible. At the rear side of the flexible inner wall, there is a cylindrical locating element that forms an interference fit with the motional sleeve. The linear reciprocating mechanism causes the motional sleeve to reciprocate, thereby compressing and relaxing the flexible inner wall through the cylindrical locating element. As a result, the compression and relaxation of the flexible inner wall lead to an alternate increase and decrease in the volume of the chamber and the generation of alternating negative and positive relative pressures inside the chamber, relative to the ambient pressure. These alternating negative and positive pressures create a suction effect in the detachable suction head, resulting in sexual stimulation of the user when the opening in the chamber is in contact with a portion of the user's body.

In another embodiment, the stimulation device, as disclosed in the above embodiment, is constructed with a modified design of a detachable suction head. The detachable suction head consists of a flexible outer wall that is concentrically mounted to a mouth portion of the housing and an elastic membrane spanning the inner surface of the flexible outer wall. The flexible outer wall and the elastic membrane are arranged in a manner that defines a chamber between them, forming an opening configured to engage with a portion of a user's body. The elastic membrane causes compression and relaxation within the chamber through the reciprocating motion of the motional sleeve. This compression and relaxation alternately increase and decrease the volume of the chamber, respectively. As a result, positive and negative pressures are generated within the chamber, thereby sexually stimulating the user's body.

In yet another embodiment, a detachable suction head is disclosed. The detachable suction head can be removably attached to a housing of the stimulation device through a suitable fastener such as a magnetic fastener, a snap-fit fastener, etc. The detachable suction head has a flexible inner wall and an outer wall. The flexible inner wall and the outer wall collectively define a chamber. The flexible inner wall is an elastic membrane and the outer wall is flexible. The elastic membrane periodically impacts within the chamber, thereby alternatively causing compression and relaxation that generates a change in air pressure within the chamber. This provides sexual stimulation to the portion of the body of the user through the opening of the chamber.

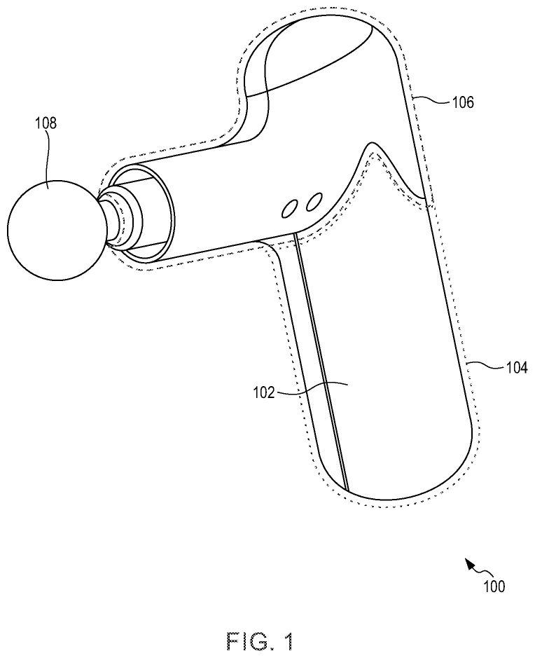

Various example embodiments of the present disclosure are described hereinafter with reference to FIG. 1 to FIG. 6.

FIG. 1 illustrates a perspective view of a stimulation device 100, in accordance with an embodiment of the present disclosure. The stimulation device 100 is designed to provide sexual stimulation to one or more body parts (e.g., vagina, clitoris, penis, etc.) of a user. The stimulation device 100 includes a housing 102 (also referred to as “a fascial gun housing 102”) configured to accommodate one or more components therein. The stimulation device 100 illustrated in the disclosed embodiment is a fascial gun that includes a first portion 104 and a second portion 106. The first portion 104 is orthogonally oriented with respect to the second portion 106. For enhanced user experience, the first portion 104 is designed as a gripper, facilitating a secure hold on the stimulation device 100 during operation. This is achieved through the incorporation of one or more gripping profiles, such as grooves, dimples, cross patterns, or similar structures, which generate a frictional effect against the user's palm. As a result, the likelihood of the stimulation device 100 slipping from the user's palm during operation is effectively eliminated.

The second portion 106 may be constructed in a manner to detachably secure at least a part of a detachable stimulator 108. In the illustrated embodiment, the detachable stimulator 108 of the stimulation device 100 is a massage head that increases sexual arousal and pleasure to the user. The stimulation device 100 is designed such that the detachable stimulator 108 is replaceable.

In another embodiment, any other detachable stimulator 108 such as a dildo, a rabbit vibrator, a wand vibrator, a clitoral vibrator, a butt plug, etc. can be used for sexual stimulation of the user.

Also, it should be noted that the geometrical configuration of the stimulation device 100 disclosed herein is not limited to the fascial gun, other variants of the stimulation device 100 are also possible.

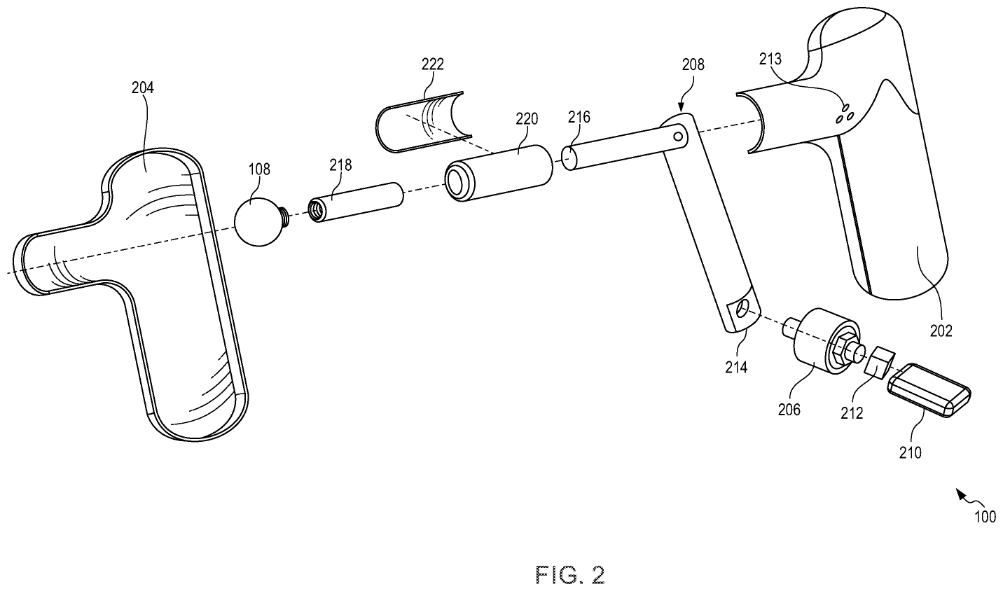

FIG. 2 illustrates an exploded view of the stimulation device 100 of FIG. 1, in accordance with an embodiment of the present disclosure. As shown, the housing 102 is constructed in a manner to be split at least into two parts, namely, a front part 202 and a rear part 204. The front part 202 and the rear part 204 of the housing 102 are assembled or dissembled together through suitable openable joints. In a non-limiting example, an adhesive may be applied on contacting surfaces of the front part 202 and the rear part 204 for assembly of the stimulation device 100.

The stimulation device 100 includes a drive unit 206 and a linear reciprocating mechanism 208. The drive unit 206 receives electric power from a power source 210 and converts the electric power into mechanical work. In the illustrated configuration, the drive unit 206 is a motor. The power source 210 is coupled to the drive unit 206 through a controller 212. The power source 210 may provide an alternating current or a direct current as per the configuration of the drive unit 206.

In another configuration, the power source 210 may be a battery (e.g., a lithium-ion battery) designed to drive the drive unit 206. The controller 212 controls the power supply to the drive unit 206. Based on regulating the power supply to the drive unit 206, the rotational speed of the drive unit 206 can be altered. In an example, the controller 212 regulates at least one of rotational speed, rotational torque, driving voltage, and driving current of the drive unit 206.

Furthermore, one or more switch elements 213 may be installed on one of the front part 202 or the rear part 204 of the housing 102 to operate and control the working of the stimulation device 100. In the illustrated embodiment, the one or more switch elements 213 are installed on the front part 202. The one or more switch elements 213 may be electrically connected to the controller 212 that adjusts one or more input parameters of the drive unit 206. The input parameters of the drive unit 206 may be a rotational speed, rotational torque, driving voltage, driving current, etc. In one example, one of the switch elements 213 may be provided to regulate the speed of the drive unit 206, and another one of the switch elements 213 acts as a light emitting diode (LED) light that is being operated by the controller 212 to notify the user about availability of the power in the power source 210.

The drive unit 206 (e.g., motor) disposed in the housing 102 is compact in design and serves the purpose of converting electrical energy into mechanical work (i.e., shaft work). The drive unit 206 may be secured to one of the front part 202 or the rear part 204 of the housing 102 through suitable fasteners. In a non-limiting example, a screw joint may be used to secure the drive unit 206 with one of the front part 202 or the rear part 204 of the housing 102. The housing 102 may act as a damper to absorb the vibration of the drive unit 206 that occurred during the running conditions.

The linear reciprocating mechanism 208 has a proximal end 214 and a distal end 216. The proximal end 214 is operably connected to the drive unit 206 to convert a rotary motion of the drive unit 206 into a reciprocating motion of the linear reciprocating mechanism 208. In the illustrated embodiment, the linear reciprocating mechanism 208 includes a slider-crank mechanism.

The slider crank mechanism converts a rotary motion of the drive unit 206 into a reciprocating motion of the linear reciprocating mechanism 208.

The distal end 216 of the linear reciprocating mechanism 208 is connected to a motional member 218 and the detachable stimulator 108 is detachably connected to the motional sleeve 218. The motional member 218 disclosed in the illustrated embodiment has a sleeve-like profile. Hereinafter, the motional member 218 is alternatively referred to as a motional sleeve 218. The motional sleeve 218 is configured to cause reciprocating motion with respect to a stationary sleeve 220. In the illustrated configuration, the stationary sleeve 220 has a hollow cylindrical profile configured to provide reciprocating motion to the motional sleeve through the stationary sleeve 220. For instance, the motional sleeve 218 has a solid cylindrical shape identical to the shape of the cylindrical profile of the stationary sleeve 220. The stationary sleeve 220 is mounted to the housing 102 through a suitable holding member. In the illustrated embodiment, a holding gasket 222 is used to hold the stationary sleeve 220 to the housing 102. Consequently, the holding gasket 222 constraints a movement of the stationary sleeve 220 with respect to the housing 102.

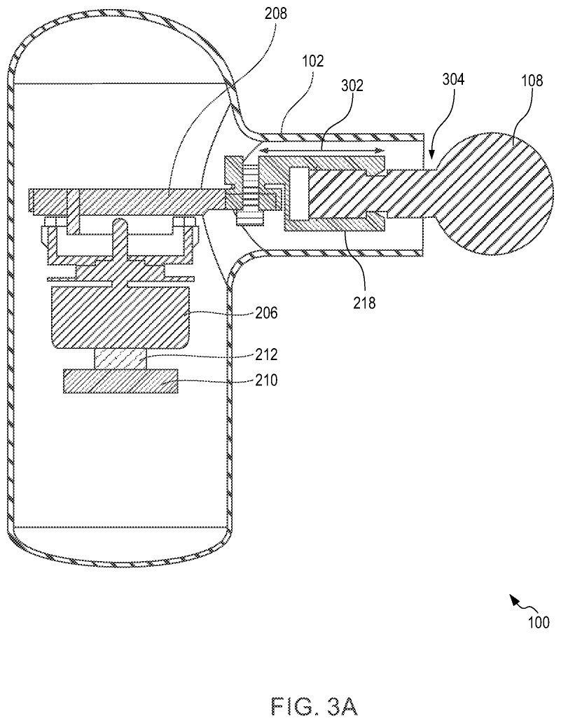

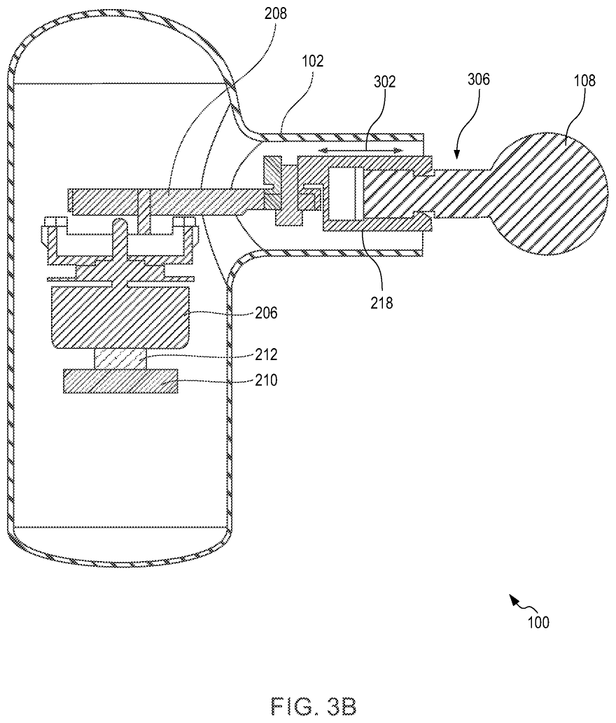

FIG. 3A illustrates a sectional view of the stimulation device 100 in a backward position of the motional sleeve 218 of FIG. 1, in accordance with an embodiment of the present disclosure. FIG. 3B illustrates a sectional view of the stimulation device 100 in a forward position of the motional sleeve 218 of FIG. 1, in accordance with an embodiment of the present disclosure. As shown, the linear reciprocating mechanism 208 converts the rotary motion of the drive unit 206 into the reciprocating motion of the motional sleeve 218. As the detachable stimulator 108 (e.g., massage head) is detachably coupled to the motional sleeve 218, the detachable stimulator 108 may reciprocate along a reciprocation direction 302 of the motional sleeve 218. A backward state 304 of the detachable stimulator 108 is illustrated in FIG. 3A. In this state, the detachable stimulator 108 may not be in contact with the body portion (e.g., clitoris) of the user. A forward state 306 of the detachable stimulator 108 is illustrated in FIG. 3B. In this state, the detachable stimulator 108 is in contact with the body portion (e.g., clitoris) of the user.

In one configuration, the detachable stimulator 108 is detachably connected to the motional sleeve 218 through a snap-fit arrangement. Consequently, the massage head can be replaced with another detachable stimulator 108 such as the dildo, the rabbit vibrator, the wand vibrator, the clitoral vibrator, the butt plug, etc., based on the sexual desire of the user. However, in another configuration, the detachable stimulator 108 can be detachably connected to the motional sleeve 218 through a magnetic fastener.

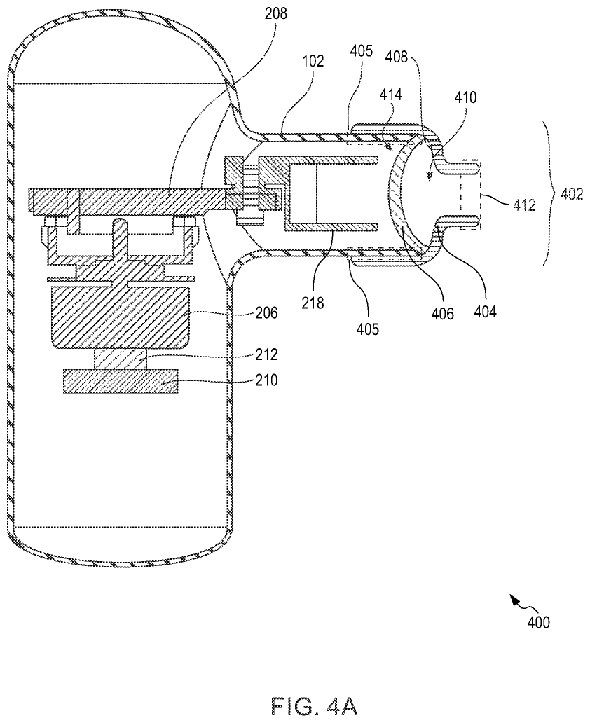

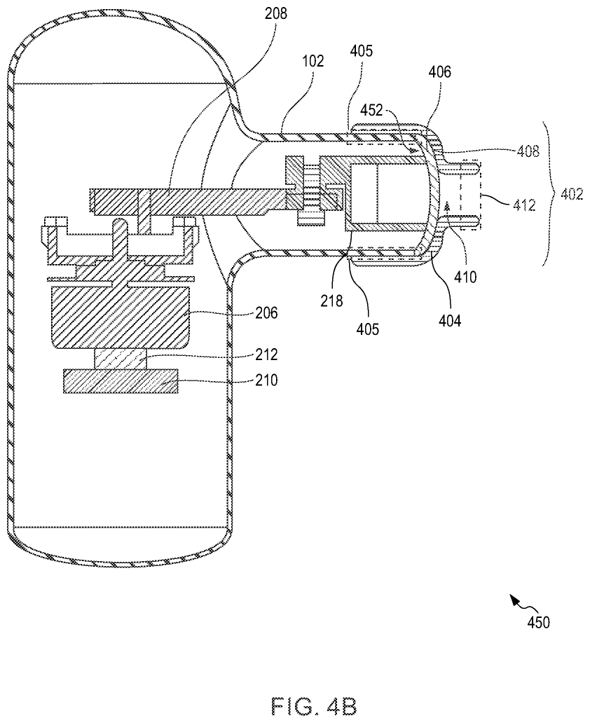

FIG. 4A illustrates a sectional view 400 of the stimulation device 100 in the backward position of the motional member 218, in accordance with another embodiment of the present disclosure. FIG. 4B illustrates a sectional view 450 of the stimulation device 100 in a forward position of the motional member 218, in accordance with another embodiment of the present disclosure. As shown, the stimulation device 100 has a detachable suction head 402. In this embodiment, the detachable suction head 402 is used instead of the detachable stimulator 108. The detachable suction head 402 includes an outer wall 404. The outer wall 404 is flexible and configured to be concentrically located at a mouth portion 405 of the fascial gun housing 102. The detachable suction head 402 further includes an elastic membrane 406 spanning an inner surface 408 of the outer wall 404. Further, the elastic membrane 406 is concentric with the outer wall 404. The outer wall 404 and the elastic membrane 406 define a chamber 410.

In accordance with another embodiment of the present disclosure, the chamber 410 has an opening 412 that is configured to engage with a portion of the body of the user. The motional member 218 is not connected to the elastic membrane 406. In the illustrated configuration, the motional member 218 is periodically in contact with the elastic membrane 406, at the bottom of the elastic membrane 406, in a manner that the periodic impaction of the motional member 218 causes compression and relaxation of the elastic membrane 406. When the motional member 218 moves backward, the elastic membrane 406 is relaxed due to its own resilience. A resilience state 414 of the elastic membrane 406 is illustrated in FIG. 4B. When the motional member 218 moves forward, the elastic membrane 406 is compressed. A compressed state 452 of the elastic membrane 406 is illustrated in FIG. 4A. The alternative compression and relaxation of the elastic membrane 406 cause the volume of the chamber 410 to decrease and increase respectively. This leads to the generation of change in air pressures inside the chamber 510. The change in air in the chamber 510 generate a suction and relaxation effect on the user's body.

In accordance with another embodiment of the present disclosure, the stimulation device 100 doesn't comprise the detachable stimulator 108, and the detachable suction head 402 approximates the FIG. 4A and FIG. 4B, but the outer wall 404 of the detachable suction head 402 and the housing 102 are formed in one piece.

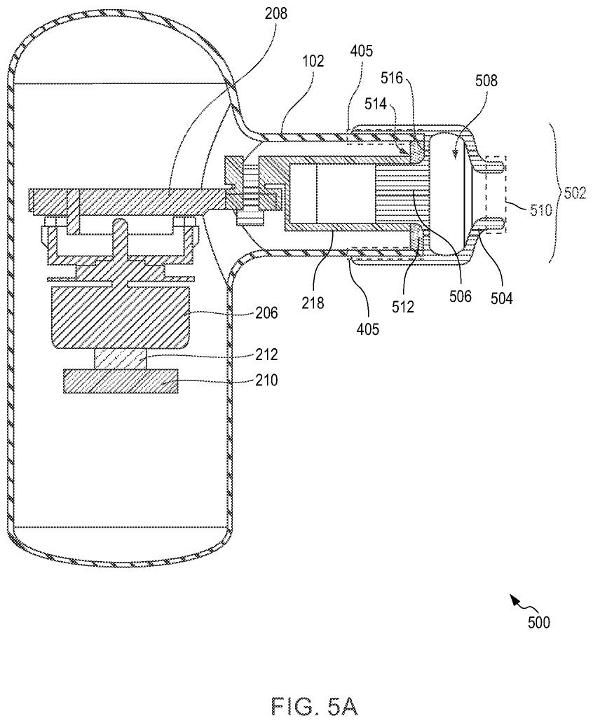

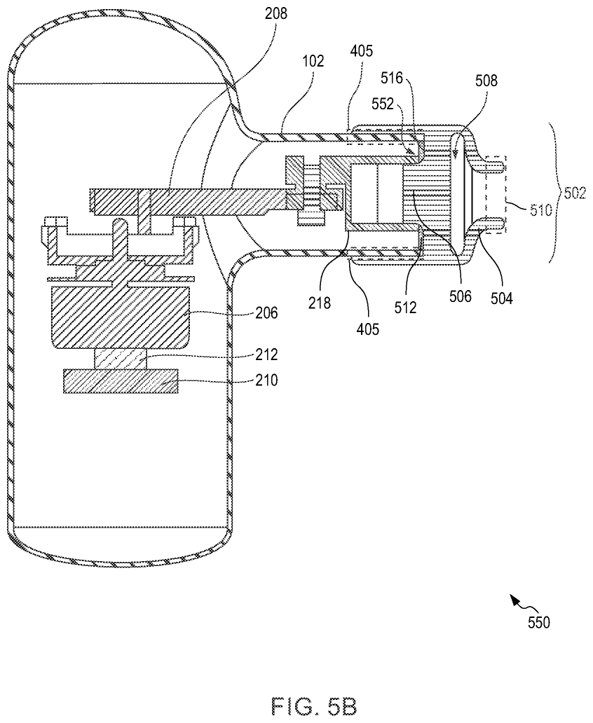

FIG. 5A illustrates a sectional view 500 of the stimulation device 100 in the backward position of the motional sleeve 218, in accordance with yet another embodiment of the present disclosure. FIG. 5B illustrates a sectional view 550 of the stimulation device 100 in the forward position of the motional sleeve 218, in accordance with yet another embodiment of the present disclosure. Herein, the design of a detachable suction head 502 is changed. The stimulation device 100 has the detachable suction head 502 that includes an outer wall 504 and a flexible inner wall 506. The outer wall 504 is flexible and configured to be concentrically mounted at the mouth portion 405 of the fascial gun housing 102.

A chamber 508 is defined by the outer wall 504 and the flexible inner wall 506. The chamber 508 has an opening 510 that is configured to engage with a portion of the body of the user. The flexible inner wall 506 includes a cylindrical locating element 512 on a rear side 516 of the flexible inner wall 506. The motional sleeve 218 forms an interference fit with the cylindrical locating element 512 in a manner that reciprocating motion of the motional sleeve 218 causes compression and relaxation of the flexible inner wall 506. When the motional sleeve 218 moves backward, the flexible inner wall 506 is relaxed due to its own resilience. A resilience state 514 of the flexible inner wall 506 is illustrated in FIG. 5A. When the motional sleeve 218 moves forward, the flexible inner wall 506 is compressed. A compressed state 552 of the flexible inner wall 506 is illustrated in FIG. 5B. The compression and relaxation of the flexible inner wall 506 causes the volume of the chamber 508 to increase and decrease and generation of negative and positive relative pressures inside the chamber 508. The positive and negative pressures in the chamber 508 generate a suction and relaxation effect on the body of the user.

During installation, the outer wall 504 can be turned outward toward the direction of the opening 510 before installing the detachable suction head 502 and inserting the cylindrical locating element 512 into the motional sleeve 218. Then the outer wall 504 can be flipped back to cover the housing of the fascial gun housing 102, thereby completing the installation.

In accordance with another embodiment of the present disclosure, the detachable suction head 402 is attachable to a main body of the housing 102 through a magnetic fastener or a snap-fit fastener.

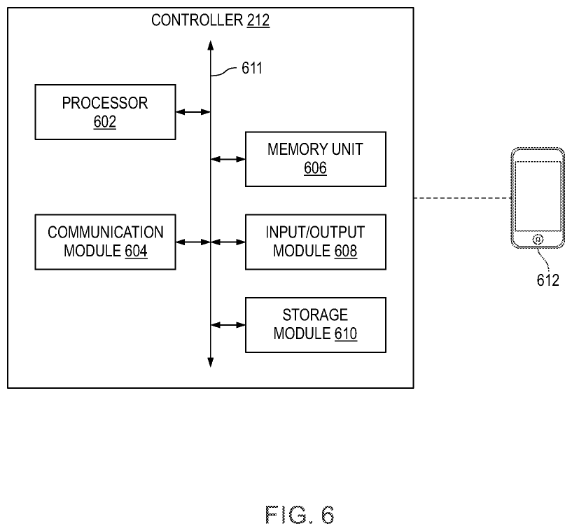

FIG. 6 is a block diagram of the controller 212 of the stimulation device 100, in accordance with an embodiment of the present disclosure. The controller 212 includes a processor 602, a communication module 604, a memory unit 606, an input/output module 608, and a storage module 610. The memory unit 606 is configured to store machine-readable instructions. The processor 602 may be a single-core processor, a multi-core processor, and/or any combination thereof. The memory unit 606 may include one or more volatile memory devices, one or more non-volatile memory devices, and/or any combination thereof. In one embodiment, the memory unit 606 stores an input signal, logic, and/or instructions that are received from a user device 612.

The input signal is received based on one or more input parameters such as rotational speed, rotational torque, driving voltage, and a driving current of the drive unit 206 provided by the user on the user device 612. In the illustrated embodiment, the user device 612 is a smartphone being used by the user. Upon receiving the input signal, the processor 602 generates a control signal and then transmits the control signal to the drive unit 206 based on generating the control signal. In one example, the memory unit 606 includes a program to regulate one or more of the rotational speed, rotational torque, driving voltage, and a driving current of the drive unit 206.

The communication module 604 may include a communication circuitry having a transceiver circuitry that further includes an antenna and other communication media interfaces to connect with other devices like smartphones, computers, etc. The communication circuitry may in at least some example embodiments enable the reception of one or more parameters of the drive unit 206.

The input/output module 608 may include a mechanism that receives an input signal and provides an output signal to an operator of the controller 212. To that effect, the input/output module 608 may include one or more input interfaces and/or one or more output interfaces. The storage module 610 is any computer-operated hardware that is suitable for storing and/or retrieving data. The various components of the controller 212, such as the processor 602, the memory unit 606, the communication module 604, the input/output module 608, and the storage module 610 are configured to communicate with each other through a centralized circuit system 611.

### Advantages of the Disclosed Embodiments

The pressure field, created by negative and positive relative pressures, excites the blood circulation of the area of skin to be stimulated, while said area of skin is indirectly massaged, thus combining two advantageous effects. The increased blood circulation makes the erogenous zone of the person concerned more sensitive, while generating an additional massage effect that serves, for example, to stimulate the erogenous zone to sexual arousal up to climax.

By the exemplary use of the temporally modifiable pressure field on the clitoris, the pressure field imitates a stimulation that usually only occurs during sexual intercourse. Likewise, the cohabitation movement generates a varying stimulus on the clitoris. It is thus a true-to-life imitation of the natural act of cohabitation, with the use of the pressure field causes neither habituation effects nor addiction. This is due in particular to the alternating use of negative- and positive-pressures (or even to the noncontinuous use of only one type of pressure).

Furthermore, the maximum applicable pressure is regularly limited by the maximum resilience of the area of skin to be stimulated. Thus, for instance, too high a negative-pressure harbors the risk of painful injury, especially in erogenous zones. Only stimulation devices working with negative-pressures are usually limited to this maximum in their mode of operation. Conversely, the combination of positive- and negative-pressures creates an extended working area of the stimulation-triggering pressure field or effect, as the working area of the pressure can now be exploited to the maximum in both the positive and negative area.

Various embodiments of the disclosure, as discussed above, may be practiced with steps and/or operations in a different order, and/or with hardware elements in configurations, which are different from those which are disclosed. Therefore, although the disclosure has been described based on these exemplary embodiments, it is noted that certain modifications, variations, and alternative constructions may be apparent and well within the scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A stimulation device, comprising:
a drive unit;
a linear reciprocating mechanism comprising a distal end as a motional member configured to couple a detachable stimulator of the stimulation device and a proximal end of the linear reciprocating mechanism operably coupled to the drive unit, wherein the linear reciprocating mechanism configured to convert a power output of the drive unit into a reciprocating motion of the motional member, thereby resulting the detachable stimulator to reciprocate; and
a housing configured to provide a covering to at least one of the drive unit and the linear reciprocating mechanism, wherein the housing comprises a mouth portion configured to allow a portion of the detachable stimulator to pass through,
wherein the detachable stimulator is a detachable suction head.

2. The stimulation device as claimed in claim 1, wherein the detachable suction head comprises:
an outer wall concentrically mounted to the mouth portion of the housing;
a flexible inner wall engaged to the outer wall and operably coupled to the motional member; and
a chamber defined by the outer wall and the flexible inner wall, wherein the chamber comprises an opening adapted to be engaged with a portion of a body of a user, and
wherein the flexible inner wall alternately causes compression and stretch through the reciprocating motion of the motional member, thus resulting in a positive pressure and a negative pressure within the chamber, respectively, for providing sexual stimulation to the portion of the body of the user through the opening of the chamber.

3. The stimulation device as claimed in claim 1, wherein the detachable suction head comprises:
an outer wall concentrically mounted to the mouth portion of the housing; an elastic membrane spanning an inner surface of the outer wall and operably coupled to the motional member; and
a chamber defined by the outer wall and the elastic membrane, wherein the chamber comprises an opening adapted to be engaged with the portion of the body of the user, and
wherein the motional member, in use, periodically impacts the elastic membrane, thereby resulting the elastic membrane alternatively to cause compression and relaxation that generates a change in air pressure within the chamber for providing sexual stimulation to the portion of the body of the user through the opening of the chamber.

4. The stimulation device as claimed in claim 2, wherein the motional member is a motional sleeve configured to engage with at least a portion of the detachable stimulator.

5. The stimulation device as claimed in claim 4, wherein the flexible inner wall comprises a cylindrical locating element on a rear side thereof, the cylindrical locating element configured to be engaged with the motional sleeve.

6. The stimulation device as claimed in claim 5, wherein a connection between the cylindrical locating element and the motional sleeve forms an interference fit.

7. The stimulation device as claimed in claim 2, wherein the outer wall is flexible.

8. The stimulation device as claimed in claim 1, wherein the detachable suction head is attachable to a main body of the housing through a magnetic fastener or a snap-fit fastener.

9. The stimulation device as claimed in claim 3, wherein the elastic membrane is relaxed due to its own resilience as the motional member moves backward.

10. The stimulation device as claimed in claim 3, wherein the motional member is periodically in contact with the elastic membrane as the motional member, in use, periodically impacts the elastic membrane.

11. The stimulation device as claimed in claim 1, further comprising a stationary sleeve mounted to the housing, wherein the stationary sleeve is configured to allow the reciprocating motion of the motional member.

12. The stimulation device as claimed in claim 11, wherein the stationary sleeve is mounted to the housing through a holding gasket.

13. The stimulation device as claimed in claim 1, wherein the linear reciprocating mechanism comprises at least one of a crank-link mechanism, a ball screw mechanism, a belt-drive linear actuator, a linear motor, a slider-crank mechanism, a hydraulic linear actuator, or a pneumatic linear actuator.

14. The stimulation device as claimed in claim 1, wherein the detachable stimulator comprises at least one of a massage head, a dildo, a rabbit vibrator, a wand vibrator, a clitoral vibrator, and a butt plug.

15. A stimulation device, comprising:
a housing having a mouth portion;
a drive unit covered by the housing;
a chamber located at the mouth portion, the chamber comprising an elastic membrane and an opening adapted to be engaged with a portion of a body of a user, wherein the opening is a single opening of the chamber to an exterior of the stimulation device; and
a linear reciprocating mechanism having a distal end, the linear reciprocating mechanism configured to convert a power output of the drive unit into a reciprocating motion of the distal end,
wherein the distal end periodically impacts the elastic membrane, in use, thereby resulting the elastic membrane to alternatively cause compression and relaxation that generates a change in air pressure within the chamber for providing sexual stimulation to the portion of the body of the user through the opening of the chamber.

16. A detachable suction head, comprising:
an outer wall configured to concentrically mounted to a mouth portion of a stimulation device;
a flexible inner wall engaged to the outer wall; and
a chamber defined by the outer wall and the flexible inner wall, wherein the chamber comprises an opening adapted to be engaged with a portion of a body of a user, wherein the opening is a single opening of the chamber to an exterior of the stimulation device when the outer wall engages with the mouth portion.

17. The detachable suction head as claimed in claim 16, wherein the flexible inner wall alternately causes compression and stretch through a reciprocating motion that alternately generates a positive pressure and a negative pressure within the chamber providing sexual stimulation to the portion of the body of the user through the opening of the chamber.

18. The detachable suction head as claimed in claim 16, wherein the flexible inner wall is an elastic membrane, and wherein the elastic membrane being periodically impacts, in use, thereby resulting the elastic membrane alternatively causes compression and relaxation that generates a change in air pressure within the chamber providing sexual stimulation to the portion of the body of the user through the opening of the chamber.

19. The detachable suction head as claimed in claim 16, wherein the outer wall is flexible.

20. The detachable suction head as claimed in claim 16, wherein the detachable suction head is attachable to a housing of the stimulation device through a magnetic fastener or a snap-fit fastener.
